(19) United States
(12) Patent Application Publication
(10) Pub. No.: US 2018/0364104 A1
(43) Pub. Date: Dec. 20, 2018

(54) DETERMINING TEMPERATURE OF PRINT ZONE IN ADDITIVE MANUFACTURING SYSTEM

(71) Applicant: Hewlett-Packard Development Company, L.P., Houston, TX (US)

(72) Inventors: Xavier Vilajosana, Sant Cugat del Valles (ES); Juan Manuel Valero Navazo, Sant Cugat del Valles (ES); Marina Ferran Farres, Barcelona (ES)

(73) Assignee: Hewlett-Packard Development Company, L.P., Houston, TX (US)

(21) Appl. No.: 15/747,055

(22) PCT Filed: Oct. 27, 2015
(86) PCT No.: PCT/EP2015/074914

§ 371 Date: Jan. 23, 2018

(51) Int. Cl. G01J 5/08; G01J 5/52; B29C 64/393; B29C 64/295

(52) U.S. Cl. CPC G01J 5/0846; G01J 5/522; G01J 2005/0048; B29C 64/295; B29C 64/393

(57) ABSTRACT

Examples of determining the temperature of a print zone in an additive manufacturing system are described. In one case, the additive manufacturing system comprises a print zone, a radiation source, an infra-red sensor and an ambient light sensor. The infra-red sensor is configured to measure the temperature of the print zone, and the ambient light sensor is configured to measure visible electromagnetic radiation. The additive manufacturing system comprises a temperature controller to compensate data from the infra-red sensor for infra-red radiation from the radiation source using data from the ambient light sensor.

### BACKGROUND

Additive manufacturing systems that generate three-dimensional objects, including those commonly referred to as “3D printers”, have been proposed as a potentially convenient way to produce three-dimensional objects. In these systems, materials may be deposited in layers upon a print bed in a print zone. In order to maximize the accuracy and homogeneity of the produced objects, the temperature of a print zone may be monitored during the manufacturing process. This may be achieved with, for example, an infra-red sensor. Variations in temperature across the print zone may lead to objects with inferior mechanical properties. Accurate temperature measurements based on sensor readings may be used to control the temperature of the print zone.

### BRIEF DESCRIPTION OF THE DRAWINGS

Various features of the present disclosure will be apparent from the detailed description which follows, taken in conjunction with the accompanying drawings, which together illustrate, features of certain examples, and wherein:

FIG. 1 is a schematic diagram showing temperature control components of an additive manufacturing system according to an example;

FIG. 2 is a schematic diagram showing build components of an additive manufacturing system according to an example;

FIG. 3A is a chart showing a radiation spectrum measured from a print zone according to an example;

FIG. 3B is a chart showing the radiation spectrum of FIG. 3A together with a radiation spectrum from a radiation source according to an example;

FIG. 3C is a chart showing how the radiation spectrum measured from a print zone and the radiation spectrum from the radiation source may combine according to an example;

FIG. 3D is a chart showing a range of an ambient light sensor in relation to the spectra shown in FIG. 3C according to an example;

FIG. 4 is a flowchart showing a method for determining a temperature of a print zone in an additive manufacturing system according to an example; and

FIG. 5 is a schematic diagram showing an example set of set of computer-readable instructions within a non-transitory computer-readable storage medium.

### DETAILED DESCRIPTION

In certain additive manufacturing systems, a print zone may be heated. The print zone may for example comprise a print bed. An additive manufacturing system may be supplied with a print bed. Alternatively, an additive manufacturing system may be supplied without a print bed such that a user may fit a print bed in the print zone. The print zone may be heated using a radiation source such as a short-wave incandescent lamp. The radiation source may primarily emit electro-magnetic radiation within a particular range of wavelengths (e.g. infra-red, visible or ultra-violet ranges) but also have, or cause, an emission spectrum with components outside of this primary range. In systems that measure print zone temperature using at least one infra-red sensor, electro-magnetic radiation from such a source may be detected by said sensor, interfering with, and limiting the accuracy of, the measurement of the print zone temperature. This, in turn, limits the accuracy and homogeneity of the produced objects. For example, a radiation source may add to a spectrum recorded by an infra-red sensor, leading to error in a temperature measurement made using the infra-red sensor.

In comparative examples, interference from a radiation source may be characterized and used to compensate infra-red sensor readings. For example, a data sheet for a radiation source indicating an emitted spectrum may be used to manually correct infra-red sensor readings. However, these comparative approaches result in difficulties and inaccuracies. For example, different environments, different configurations and/or different times of use may result in different patterns of sensor interference that deviate from the characterizations. Also, use of more than one radiation source may be difficult to characterize and compensate.

Certain examples describe herein make use of ambient light measurements, e.g. measurements of electro-magnetic radiation in visible wavelengths, to determine interference from at least one radiation source and to compensate measurements from an infra-red sensor accordingly. For example, data from an ambient light sensor positioned to complement the infra-red sensor may be used to infer an amount of radiation due to radiation sources present in the environment, which is then used to compensate data from the infra-red sensor and provide an accurate temperature of a print zone.

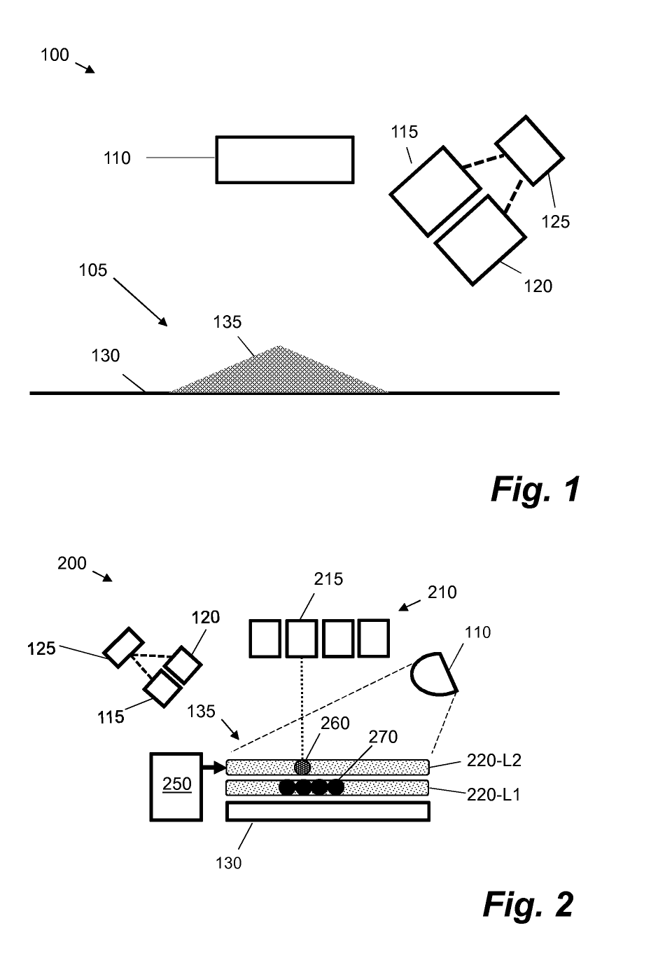

FIG. 1 shows an additive manufacturing system 100 according to an example. The additive manufacturing system 100 comprises a print bed in a print zone 105, a radiation source 110 to heat the print zone 105, an infra-red sensor 115 to measure a temperature of the print zone, an ambient light sensor 120 and a temperature controller 125. The print bed may comprise a build surface 130, such as a platen or other support, and an object 135 being generated through additive manufacture. The object may be built by iteratively configuring layers of build material. As such, the print zone 105 may comprise the build surface 130 and a series of deposited layers of material. The ambient light sensor 120 is positioned in an orientation corresponding to the infra-red sensor 115. For example, in FIG. 1 it is positioned next to and facing in the same direction as the infra-red sensor 115. This orientation may be such that the infra-red sensor 115 and ambient light sensor 120 are facing the print zone 105. In a general case, the ambient light sensor 120 may be oriented such that it detects ambient light in the vicinity or environment of the infra-red sensor 115. The temperature controller 125 is configured to compensate data from the infra-red sensor 115 for infra-red radiation from the radiation source using data from the ambient light sensor 120.

In certain examples, the radiation source 110 may comprise a lamp, for example a short-wave incandescent lamp. In other examples, the radiation source 110 may be another light source constructed to emit electro-magnetic radiation across a range of wavelengths to heat the print zone 105. For example, the radiation source 110 may be a halogen lamp. In certain cases, the additive manufacturing system 100 may comprise additional radiation sources to heat the print zone 105. In certain cases, radiation sources may have other uses, e.g. may comprise lighting systems to illuminate the print zone or to cure a build material.

The infra-red sensor 115 may comprise a thermal imaging camera. In certain cases, a thermal imaging camera may comprise a plurality of infra-red sensors. The infra-red sensor 115 may be arranged to measure radiation within a wavelength range. This wavelength range may comprise wavelengths longer than those of visible light. For example, the infra-red sensor 115 may be arranged to measure radiation in any sub-range within a wavelength range starting at 700 nm and extending to 1.5 mm. In one example, the infra-red sensor may comprise an array of thermopiles and an optical system such that the infra-red sensor is an infra-red camera. The optical system may typically comprise a system of lenses such that an infra-red image is formed by the infra-red camera. In such an example, each thermopile may return a value representative of radiation integrated within its spectral window. For example, the infra-red sensor may be an HTPA Thermopile Array as produced by Heimann Sensor GmbH of Dresden, Germany. In other examples, the infra-red sensor may comprise a single thermopile. If the infra-red sensor 115 is orientated towards the print zone 105, then a temperature of the print zone may be derived based on measured radiation within the sub-range of the infra-red sensor 115. For example, radiation emitted from the print zone 105, e.g. emitted from material forming an object on the build surface 130, may be measured and used to determine the temperature of the object being built. Temperature may be measured for a current upper layer of build material and/or may be measured or inferred for a body of lower layers of build material.

In certain cases, the ambient light sensor 120 may comprise a sensor arranged to measure radiation within a wavelength range of between 400 nm to 700 nm, wherein the exact range may depend on the model of sensor that is being used. As heat energy radiated from the print zone 105 does not have a substantial visible light component, a measurement of visible light by the ambient light sensor 120 indicates a level of energy that results from the at least one radiation source. From this level of energy, accurate characterization of the radiation source, or sources, may be achieved, i.e. an amount of infra-red radiation that results from the at least one radiation source, as opposed to the temperature of the print zone may be determined and used to compensate a measurement from the infra-red sensor 115. In the present case, accurate measurement of print zone temperature is possible, even if the radiation source 110 and any additional radiation sources have different intensities and/or emit radiation with different spectra, or if environmental conditions change. In these cases, the measurement of the ambient light sensor 120 is dependent on the operating conditions and so varies if the operating conditions vary, e.g. if additional sources are activated or if a modulation of active radiation sources is varied. The examples may moreover operate with sources in a variety of locations and/or orientations, where these may all modify a “default” or “theoretical” radiation spectrum for the source. The examples also operate successfully in the presence of interfering radiation sources.

In certain cases, the additive manufacturing system 100 may comprise multiple ambient light sensors, i.e. at least one ambient light sensor in addition to ambient light sensor 120. This allows the use of an ambient light sensor 120 and at least one additional ambient light sensor with a field of view narrower than the field of view of the infra-red sensor 115. For example, each ambient light sensor may measure ambient light associated with a particular sub-area of the print zone. In certain cases, it may be most cost-effective to use a plurality of cheaper sensors with narrow fields of view as compared with a more expensive ambient light sensor with a larger field of view, such as a comparable field of view to that of the infra-red sensor 115.

The use of additional ambient light sensors may also allow compensation of a set of measurements of temperature across the print zone 105. For example, each additional ambient light sensor may be positioned in an orientation corresponding to a control zone of the infra-red sensor 115, where control zones are regions of the print zone 105 between which the temperature may be differentially controlled. For example, the infra-red sensor 115 may measure temperature at certain key points on the print zone 105, for example in a grid; each ambient light sensor may then measure ambient light associated with that zone.

FIG. 2 shows one possible example 200 of an additive manufacturing system. In the example of FIG. 2 an inkjet deposit mechanism 210 is used to print a plurality of liquid agents onto layers of a powdered substrate. Although the example of FIG. 2 is provided to better understand the context of the examples described herein, those examples may be applied to a variety of additive manufacturing systems including, amongst others, selective laser sintering systems, stereo lithography systems, other inkjet systems, fused deposition modelling systems, and laminated object manufacturing systems. These include apparatus that directly deposit materials rather than those described with reference to FIG. 2 that use various agents.

In FIG. 2, an inkjet deposit mechanism 210 comprises inkjet printheads 215. Each inkjet printhead is adapted to deposit an agent onto a powdered polymer substrate 220. In particular, each inkjet printhead is arranged to deposit a particular agent upon defined areas within a plurality of successive substrate layers, e.g. successive layers of build material. An agent may act as a coalescing agent (e.g. a binder) or as a coalescing modifier (e.g. an inhibitor).

In FIG. 2, the additive manufacturing system comprises a substrate supply mechanism 250 to supply at least one substrate layer upon which the plurality of materials are deposited by the deposit mechanism 210. In this example the substrate supply mechanism 250 comprises a powdered substrate supply mechanism to supply successive layers of substrate. Two layers are shown in FIG. 2: a first layer 220-L1 upon which a second layer 220-L2 has been deposited by the substrate supply mechanism 250. In certain cases, the substrate supply mechanism 250 is arranged to move relative to the build surface 130 such that successive layers are deposited on top of each other. In this case, following “printing” of the agents, the “build material” upon the build surface comprises a mixture of the powdered substrate and any deposited agent liquid.

In the present example, the additive manufacturing system also comprises a radiation source 110, such as that shown in FIG. 1, which is arranged to apply energy to form portions of the three-dimensional object from combinations of the agents and the powdered substrate. For example, FIG. 2 shows a particular printhead 215 depositing a controlled amount of a fluid agent onto an addressable area of the second layer 220-L2 of powdered substrate. The fluid agent is absorbed by the powdered substrate and as such a drop of agent on an addressable area unit of the layer relates to a print resolution voxel 260, wherein the height of the voxel in the z-dimension is controlled by the depth of each substrate layer. Placement instructions from a print control system (not shown) may control the operation of the printhead 215 to form the voxel 260.

Following application of the agent, the radiation source 110 is arranged to fix or solidify the portion of the layer 260. In one case, the radiation source 110 may apply energy to a combination of coalescing agent and substrate, wherein presence of an agent in the form of a coalescence modifier may also be used to prevent fixing in certain “blank” or “empty” portions, e.g. at edges of a solid object. The application of energy may melt the substrate, which then mixes with the agent and subsequently coalesces. Use of coalescing agents and modifiers may allow a three-dimensional object to have varying material properties. FIG. 2 shows four print resolution voxels 270 that have been fixed in the first layer 220-L1. As such, the voxel 260 may be built on these previous voxels 270 to build the three dimensional object 135 undergoing additive manufacture. Lower layers of substrate may also provide support for overhanging fixed portions of a three-dimensional object, wherein at the end of production the substrate is removed to reveal the completed object.

In FIG. 2, the additive manufacturing system 200 also comprises an ambient light sensor 120 and an infra-red sensor 115 connected to a temperature controller 125 as described above with reference to FIG. 1.

The temperature of the print zone 105 may be monitored in order to maximize the accuracy and homogeneity of the object 135 undergoing additive manufacture. In one case, the operation of the radiation source 110 may be modulated, e.g. using pulse width modulation of at least one heating lamp, based on the measured temperature of the print zone. In these case, the infra-red sensor 115 and the ambient light sensor 120 may comprise part of a feedback control loop, wherein a desired print zone temperature is set based on manufacturing control data.

In some examples, additive manufacturing system 100, 200 may comprise multiple radiation sources, each corresponding to a different region or control zone of the print zone 105 such that the temperature of the print zone 105 may be regionally controlled. For example, if the temperature of a given region is measured to be too high or too low with reference to a target temperature, the output of the radiation sources may be differentially adjusted to compensate. The target temperature may or may not vary by region. For example, the target temperature may be homogeneous across regions of the build surface 130 where no object 135 is present. Alternatively or additionally, the target temperature may vary across the object 135 undergoing additive manufacture based on the parameters of the additive manufacturing process.

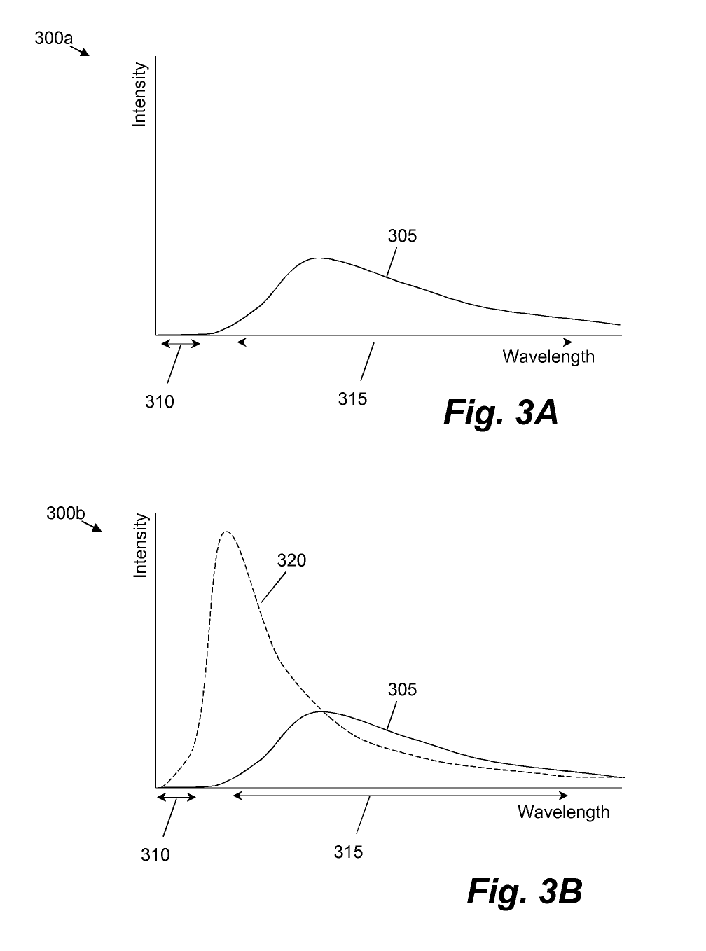

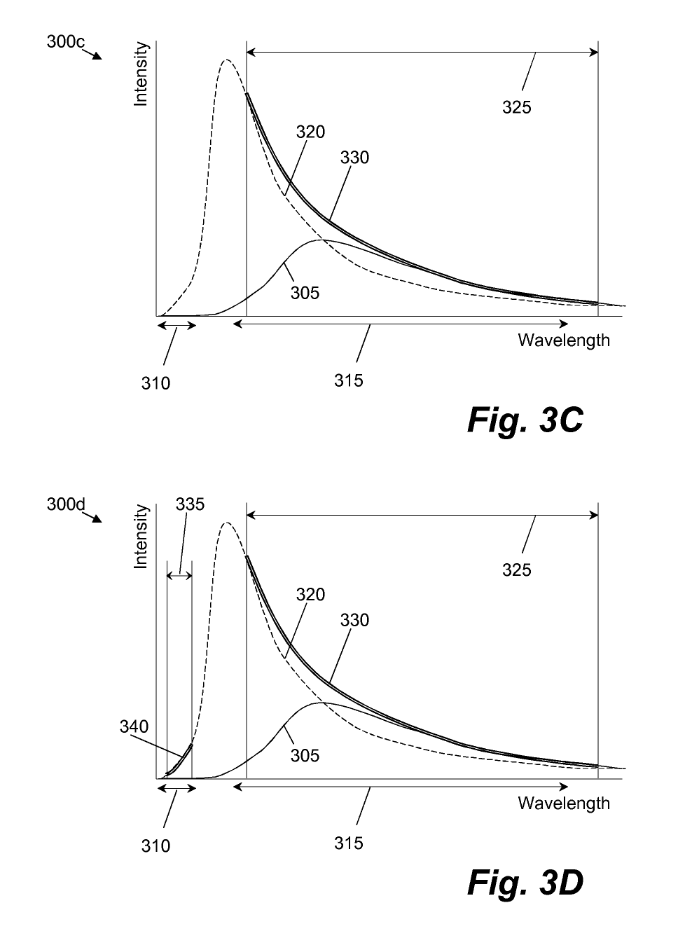

The operation of certain examples described herein will now be described with reference to example electro-magnetic spectra. These are shown in FIGS. 3A to 3D.

FIG. 3A shows a first chart 300a with an example spectrum 305 of radiation from the print zone 105. The shape of the spectrum 305 depends in part on the temperature of the print zone 105. The chart shows intensity of radiation (e.g. irradiance) expressed as a function of wavelength. A first wavelength range 310 comprises a range of wavelengths associated with visible light, and a second wavelength range 315 comprises a range of wavelengths associated with infra-red radiation. It can be seen that there is a low intensity of radiation at wavelengths associated with visible light, and a higher intensity of radiation at wavelengths associated with infra-red radiation. The first wavelength range 310 may be from 400 to 700 nm and the second wavelength range 315 may be from 1.5-2 μm to 12-15 μm. In certain implementations, the spectrum 305 may have a peak irradiance value of around 7-8 wm⁻².

FIG. 3B shows a second chart 300b comprising the spectrum 305 from the first chart 300a and also an example spectrum 320 of radiation emitted by a radiation source, such as 110 in FIG. 1. This radiation may be reflected from the print zone 105, for example from the build surface 130 or from the object 135 undergoing additive manufacture. Alternatively, it may be directly incident on the infra-red sensor 115 from the radiation source 110. It can be seen that, despite emitting mainly at wavelengths associated with infra-red radiation, the radiation source 110 emits significantly more radiation at wavelengths associated with visible light than does the print zone 105. For example, the spectrum 320 may have a peak irradiance value of around 55-60 wm⁻² at a wavelength of around 1.5 μm. Additionally, the radiation source results in energy that is emitted within the infra-red wavelength ranges 315 used to measure the temperature of the print zone. This distorts the reading from the infra-red sensor, such as 115 in FIGS. 1 and 2.

FIG. 3C shows a third chart 300c based on features shown in the second chart 300b. In this chart 300c, a detection range of an example infra-red sensor is shown. The infra-red sensor in this example is sensitive to radiation with wavelength within a wavelength range 325. For example, the infra-red sensor may be a sensor with a non-Anti-Reflective-Coating (ARC) silicon (Si) window, which is sensitive to radiation from 2.5 μm to 12 μm.

The third chart 300c further shows a detected spectrum 330. The detected spectrum 330 indicates the sum of the spectra 305 and 320 within the wavelength range 325; this indicates the spectrum of radiation detected by the infra-red sensor 115. The exact nature of the spectra will vary from implementation to implementation and may depend on properties such as: ambient lighting; distance of sources from the print zone and/or sensors; and a current operating setting of the sources (e.g. a current pulse width modulation level).

In examples in which the infra-red sensor differentiates radiation of different wavelengths, the infra-red sensor may output data indicative of the detected spectrum 330. In other examples, the infra-red sensor may output data indicative of the total intensity across the detected spectrum 330. As this spectrum does not match the spectrum 305 of radiation from the print zone 105, examples described herein provide compensation when calculating a temperature from this spectrum. If this is not performed, the energy emitted by the radiation source effectively blinds the infra-red sensor from an accurate temperature measurement.

FIG. 3D shows a fourth chart 300d based the features of the third chart 300c. This chart 300d shows a comparative example sensitivity of an ambient light sensor such as 120. In FIG. 3D, the ambient light sensor 120 is sensitive to light in a wavelength range 335 corresponding approximately to the wavelength range 310 associated with visible light. The ambient light sensor may be, for example, a LV0104CS ambient light sensor as produced by ON Semiconductor of Phoenix, Ariz. As the spectrum 320 of radiation emitted by the radiation source 110 has significantly higher intensity in the wavelength range 335 than the spectrum 305 of radiation from the print zone 105, a detected spectrum 340 of radiation within the wavelength range 310 may be used to determine and/or infer the spectrum 320 of light emitted by the radiation source 110. As such, the measured ambient light may be used to compensate the measured infra-red radiation in order to produce an accurate temperature measurement.

In one case, the shape and/or overall intensity of the spectrum 320 of radiation emitted by the radiation source 110 in the wavelength range 325 in which the infra-red sensor is sensitive may be inferred from the shape and/or overall intensity of the spectrum 320 as measured by the ambient light sensor 120 in its associated wavelength range 310. This inferred shape and/or overall intensity may then be subtracted from the shape and/or total intensity of the spectrum 330 detected by the infra-red sensor 115, giving a shape and/or overall intensity closer to that of the spectrum 305 of radiation from the print zone 105. From this calculation of the radiation from the print zone 105, the temperature of the print zone may be accurately determined. Other methods for compensating the measurement from the infra-red sensor 115 may also or alternatively be used. For example, the appropriate compensation may be retrieved from a lookup table based on the measurements from the ambient light sensor 120 and infra-red sensor 115.

In some examples, the compensation may be based on known details of the radiation curve of the radiation source 110. For example, the radiation curve of an incandescent lamp may be characterized as that of a black body radiator. A measurement from the ambient light sensor 120 of radiation in its associated wavelength range 310 may be combined with the known radiation curve to infer the radiation curve across a wider wavelength range including the range 325 in which the infra-red sensor 115 is sensitive. From this inferred radiation curve in the wavelength range 325, the measurement from the infra-red sensor 115 may be compensated for example by subtracting the inferred curve from the measurement as described above.

In certain examples described herein, a temperature of a print zone may be accurately determined in real time, e.g. instantaneously based on current infra-red and ambient light measurements. As the temperature is based on measurements of emitted radiation, it does not depend on assumptions of the power emitted by the radiation source. The ambient light sensor 120 and/or infra-red sensor 115 may be inexpensive standard components, thus minimizing the cost of the additive manufacturing system 100. Moreover, by using the examples described herein a low-cost infra-red sensor may also be used instead of an expensive thermocamera with complex, software-based reflected light compensation routines. Compensation is further simplified, which ensures high quality three-dimensional objects and parts. For example, extensive learning, calibration or training phases to enable reflected light compensation are avoided when using the ambient light sensor of the present examples. This saves computational complexity and time. Measuring the amount of light present using an ambient or visible light sensor ensures that correct compensation is done at each moment. As this is a direct measurement, the accuracy does not rely on a characterization that assumes that everything is working as expected or in theoretical “ideal” conditions. Indeed, certain examples described herein provide improved compensation regardless of the power, type of source, number of sources and lifetime of the heating system among many others.

In certain implementations, at least one ambient light sensor may be located in a center of a top heating portion of an additive manufacturing system, e.g. such as a desktop or industrial “3D printer”. The at least one ambient light sensor may be located close to an infra-red sensor in the form of a thermocamera. The at least one ambient light sensor may have the same orientation as the thermocamera. In a case where a view window of an ambient light sensor is not as wide as a view window of the thermocamera, several sensors may be placed in an array formation, e.g. in diagonal lines.

In certain cases, a spectral filter may also be positioned between the print zone 105 and infra-red sensor 115. In one case, the spectral filter may be configured to prevent or reduce transmission of visible light. In another case, the spectral filter (or an additional filter) between the print zone 105 and infra-red sensor 115 may raise the lower bound of the wavelength range 325 in which the infra-red sensor 115 detects radiation (e.g. from around 2.5 μm to 8 μm). This filter may be, for example, an ARC germanium (Ge) filter giving a sensitivity window to 8 to 14 μm. This in certain cases may reduce the relative contribution to the detected spectrum 330 of radiation emitted by the radiation source 110. As such, this may reduce the degree of compensation which may increase the accuracy of the temperature measurement. In any case, depending on the implementation, the infra-red sensor may differentiate radiation of different wavelengths. This may improve accuracy. In some aspects, the infra-red sensor 115 may comprise a thermal imaging camera capable of taking a two-dimensional measurement of radiation intensity. This may allow simultaneous measurements of temperature across different areas of the print zone 105.

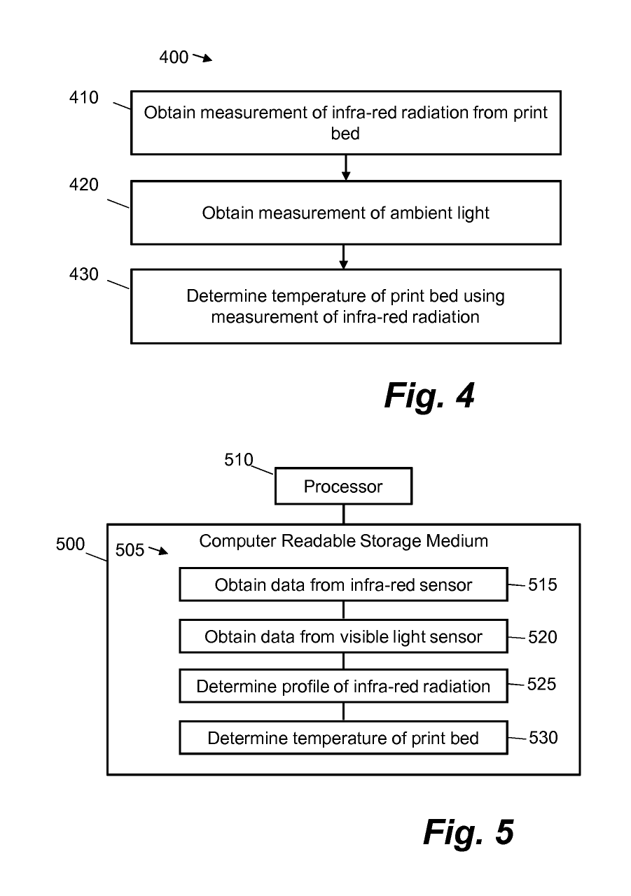

FIG. 4 shows a method 400 for determining a temperature of a print zone in an additive manufacturing system 100 according to an example. In this case, the print zone is illuminated and/or heated by a radiation source. The method may be applied to the components shown in FIGS. 1 and 2, or to alternative sets of components.

At block 410, a measurement of infra-red radiation from the print zone is obtained. As described above, the print zone may for example comprise a build surface and an object undergoing additive manufacturing.

At block 420 a measurement of ambient light is obtained. The ambient light comprises visible electromagnetic radiation, e.g. radiation in the ranges discussed above. The measurement of ambient light may for example comprise an intensity of ambient light. As described above, the ambient light may comprise light emitted by at least one radiation source, which is then reflected from the print zone, for example from the build surface 130 or from the object 135 undergoing additive manufacture, and/or otherwise received by the ambient light sensor.

At block 430, the temperature of the print zone is determined using the measurement of infra-red radiation. This includes using the measurement of ambient light to compensate for infra-red radiation from the radiation source.

Determining the temperature of the print zone may comprise inferring the intensity of infra-red radiation emitted by the radiation source based on visible light emitted by the radiation source, and adjusting the measurement of infra-red radiation from the print zone such that the contribution to the measurement of infra-red radiation from the radiation source is reduced. This adjusting may for example be performed using any of the operations described above for compensating the measurement from the infra-red sensor. In such an example, obtaining a measurement of ambient light may comprise determining a portion of an electromagnetic radiation spectrum having a first wavelength range comprising at least one visible wavelength. Inferring the intensity of infra-red radiation emitted by the radiation source may then comprise inferring a portion of the electromagnetic radiation spectrum having a second wavelength range comprising at least one infra-red wavelength. In this manner, measurements of a visible light portion of the electromagnetic spectrum may be used to infer an infra-red portion of the electromagnetic spectrum.

It should be noted that use of method/process diagrams is not intended to imply a fixed order; for example in FIG. 4, block 420 may be performed before block 410, or as another alternative blocks 410 and 420 may be performed simultaneously.

FIG. 5 shows an example of such a non-transitory computer-readable storage medium 500 comprising a set of computer readable instructions 505 which, when executed by at least one processor 510, cause the processor 510 to perform a method according to examples described herein. The computer readable instructions 505 may be retrieved from a machine-readable media, e.g. any media that can contain, store, or maintain programs and data for use by or in connection with an instruction execution system. In this case, machine-readable media can comprise any one of many physical media such as, for example, electronic, magnetic, optical, electromagnetic, or semiconductor media. More specific examples of suitable machine-readable media include, but are not limited to, a hard drive, a random access memory (RAM), a read-only memory (ROM), an erasable programmable read-only memory, or a portable disc.

In an example, instructions 505 cause the processor 510 to, at block 515, obtain data from an infra-red sensor orientated at a print zone in an additive manufacturing system, the print zone being illuminated by at least one lamp. The at least one lamp may for example be an incandescent lamp. This may be the system shown in FIGS. 1 and 2. The at least one lamp implements a radiation source. The data may, for example, comprise a measurements of infra-red radiation in a given wavelength range.

At block 520, the instructions cause the processor 510 to obtain data from a visible light sensor 120 positioned such that it senses visible light from the print zone 105. The data may, for example, comprise measurements of visible light in a given wavelength range.

At block 525, the instructions cause the processor 510 to determine a profile of infra-red radiation emitted by the lamp using the data from the visible light sensor. The profile may, for example, comprise an infra-red radiation spectrum as described above.

At block 530, the instructions cause the processor 510 to determine a temperature of the print zone 105 by adjusting the data from the infra-red sensor 115 according to the profile of infra-red radiation emitted by the lamp. As described in more detail above, this may, for example, comprise subtracting the profile of infra-red radiation from a spectrum obtained using the infra-red sensor 115.

The preceding description has been presented to illustrate and describe examples of the principles described. This description is not intended to be exhaustive or to limit these principles to any precise form disclosed. Many modifications and variations are possible in light of the above teaching. It is to be understood that any feature described in relation to any one example may be used alone, or in combination with other features described, and may also be used in combination with any features of any other of the examples, or any combination of any other of the examples.

What is claimed is:

1. An additive manufacturing system comprising:
a print zone;
a radiation source to heat the print zone;
an infra-red sensor to measure a temperature of the print zone;
an ambient light sensor positioned in an orientation corresponding to the infra-red sensor, the ambient light sensor being arranged to measure visible electromagnetic radiation; and
a temperature controller to compensate data from the infra-red sensor for infra-red radiation from the radiation source using data from the ambient light sensor.

2. The additive manufacturing system of claim 1, comprising:
a spectral filter located between the print zone and the infra-red sensor, wherein the spectral filter does not transmit visible light.

3. The additive manufacturing system of claim 1, comprising:
at least one additional ambient light sensor, wherein each of the ambient light sensor and the additional ambient light sensor have a field of view narrower than the field of view of the infra-red sensor.

4. The additive manufacturing system of claim 3, wherein each additional ambient light sensor is positioned in an orientation corresponding to a control zone of the infra-red sensor.

5. The additive manufacturing system of claim 1, wherein the infra-red sensor is a thermal imaging camera.

6. The additive manufacturing system of claim 1, comprising:
an additional radiation source to heat the print zone.

7. A method for determining a temperature of a print zone in an additive manufacturing system, the print zone receiving electro-magnetic radiation from a radiation source, the method comprising:
obtaining a measurement of infra-red radiation from the print zone;
obtaining a measurement of ambient light, the ambient light comprising visible electromagnetic radiation; and
determining the temperature of the print zone using the measurement of infra-red radiation including using the measurement of ambient light to compensate for infra-red radiation from the radiation source.

8. The method of claim 7, wherein the print zone comprises a build surface and an object undergoing additive manufacturing.

9. The method of claim 7, wherein the measurement of ambient light comprises an intensity of ambient light.

10. The method of claim 7, wherein the ambient light comprises light emitted by the radiation source, which is then reflected from the print zone.

11. The method of claim 7, wherein determining the temperature of the print zone comprises:
inferring the intensity of infra-red radiation emitted by the radiation source based on visible light emitted by the radiation source; and
adjusting the measurement of infra-red radiation from the print zone such that the contribution to the measurement of infra-red radiation from the radiation source is reduced.

12. The method of claim 11, wherein:
obtaining a measurement of ambient light comprises determining a portion of an electromagnetic radiation spectrum having a first wavelength range, the first wavelength range comprising at least one visible wavelength; and
inferring the intensity of infra-red radiation emitted by the radiation source comprises inferring a portion of the electromagnetic radiation spectrum having a second wavelength range, the second wavelength range comprising at least one infra-red wavelength.

13. A non-transitory computer-readable storage medium comprising a set of computer-readable instructions stored thereon which, when executed by at least one processor, cause the at least one processor to:
obtain data from an infra-red sensor orientated at a print zone in an additive manufacturing system, the print zone being illuminated by at least one lamp;
obtain data from a visible light sensor positioned such that it senses visible light from the print zone;
determine a profile of infra-red radiation emitted by the at least one lamp using the data from the visible light sensor; and
determine a temperature of the print zone by adjusting the data from the infra-red sensor according to the profile of infra-red radiation emitted by the at least one lamp.

14. The medium of claim 13, wherein the profile of infra-red radiation comprises an infra-red radiation spectrum.

15. The medium of claim 14, wherein said instructions cause the at least one processor to subtract the profile of infra-red radiation from a spectrum obtained using the infra-red sensor.
